(19) United States
(12) Patent Application Publication
(10) Pub. No.: US 2002/0134618 A1
(43) Pub. Date: Sep. 26, 2002

(54) Device for progressively braking the fall of a load, and life saving line equipped with said device

(76) Inventor: Francis Timmermans, Troyes (FR)

Correspondence Address: YOUNG & THOMPSON, 745 SOUTH 23RD STREET 2ND FLOOR, ARLINGTON, VA, 22202

(21) Appl. No.: 09/725,119

(22) Filed: Nov. 29, 2000

(30) Foreign Application Priority Data
Nov. 30, 1999 (FR) 99 15040

(51) Int. Cl. A62B 35/00; F16F 7/12

(52) U.S. Cl. 182/36; 182/3; 188/371

(57) ABSTRACT

Device for progressively braking the fall of a load, and life line equipped with said device.

The extremity anchorage 1 for a life line to which a user is linked consists of a single piece unit comprising a base 4 continued by a polyurethane receiving element made up of two parallel bulging parts. The extremity of a cable 2 traverses each bulging part 6 by passing into a longitudinal housing 8 of a conical portion of the bulging portion 6. A mobile part 11, traversed by the cable 2 , is applied by the extremity of said cable against the open extremity of the housing 8. If the user falls, traction is applied to the cable 2 which introduces and triggers sliding of the part 11 inside the housing 8 by warping the latter and brakes the fall.

### FIELD OF THE INVENTION

The invention concerns a device for braking the fall of a load and in particular that of a person connected to the device.

### BACKGROUND OF THE INVENTION

There currently exist systems for braking and stopping the fall of load, and in particular that of a person, said systems consisting of a mobile part to which a load is connected, said mobile part being engaged in a tube under the effect of a sudden acceleration of this load. So as to obtain braking, this tube has a lower cross section than the cross section of the mobile part, so that the latter, on being introduced into the tube, exerts a radial pressure expressed by a widening of the section of the tube over the length of the latter traversed by the mobile part. This tube has a certain consistency and is dimensioned so that its widening on a given length requires an effort absorbing the energy provoked by the fall of the load and thus resulting in stopping the fall.

This device is used specifically for life line equipment comprising an approximately horizontal cable fixed to the anchorage extremities and on which runs a mobile anchorage to which a user exposed to the risk of falling is connected by a rope. This equipment enables the user to move on an approximately horizontal plane whilst remaining constantly protected against the risk of falling.

The device described above is used in this type of equipment by fixing a tube as indicated above on each of the extremity anchorages onto which the horizontal cable is fixed. Each extremity of the cable is passed into the corresponding tube. A mobile part as mentioned above is fixed to each of the extremities of the cable and to the extremity of the corresponding tube outside the installation so as to constitute a retention piece for the corresponding extremity of this cable. If the user falls, the cable constituting the life line is powerfully stressed downwards to the location where the mobile anchorage is situated, which powerfully stresses the extremities of the cable into the axis and towards the inside of the two tubes, thus driving each mobile part into the corresponding tube. Such a system is described in the European patent N^{o} 0 605 538 and in the U.S. Pat. No. 5,458,221.

A system as described above has the drawback of having a progressively reduced braking effect which cannot be accurately predetermined. Moreover, said system requires a method for lubricating the surfaces in rubbing contact between the mobile part and the tube, this lubrication being the object of the European patent N^{o} 0 605 538 (or the U.S. Pat. No 5,458,221). In addition, the use of this system in the event of a fall of the load damages the tube and consequently the device.

The U.S. Pat. No 5,174,421 describes a shock absorber-damper for a motor vehicle seat. The device comprises a piston mounted so as to be able to slide in two opposing directions inside a tube made of a thermoplastic material packed in a fixed metal box guiding sliding of the piston rod having one extremity fixed to the vehicle seat. The external diameter of the piston is larger than the internal diameter of the tube so that should an impact occur, the piston moves inside the tube by warping the wall of the tube and dissipating the energy due to the impact. Owing to its constitutive nature, the tube via elasticity recovers its original diameter. In this device, which concerns a field of application completely different from that of the invention (absorption of impacts applied to a vehicle seat and not braking the fall of a user), the mobile part is placed idle inside the ductile body and not outside the latter. Furthermore, the box ensuring fixing and packing of the thermoplastic ductile tube is a separate metal element, contrary to the device of the invention in which the receiving element constitutes an elastic single piece fully participating in braking and damping of the fall of the load.

### SUMMARY OF THE INVENTION

The purpose of the present invention is to eliminate the above-mentioned drawbacks of known braking devices and to this effect concerns embodying a braking system for the fall of a load and in particular in a life line equipment and making it possible to improve progressiveness of the braking of the fall and to predetermine from this its development and level without having to use a lubrication method and enabling the parts of the braking system to be recovered after it has functioned for their subsequent reuse. With this end in mind, according to the present invention, the device for braking the fall of a load and more specifically of a person is of the type comprising a mobile part to which the load is connected, said mobile part penetrating and sliding under the effect of acceleration of said load into a longitudinal housing of a fixed receiving element whose initial internal diameter is smaller than the width of the mobile part, so that the receiving element via its warping under the radial force of the mobile part absorbs the energy produced by the fall of the load and accordingly brakes this fall. It is characterized in that the receiving element is constituted by a body which elastically warps under the radial force exerted by the mobile part so that progressiveness of the braking of the mobile part can be predetermined via the shape and dimensions of said element and that the latter resumes its initial shape and aptitudes after the mobile part is removed, the receiving element forming a single piece element to be secured to on a receiving structure so that the entire elastic material of said part participates via its elasticity in braking and damping the fall of the load.

Advantageously, the section of the elastic body of the receiving element transversal to the path of the mobile part becomes thicker in the direction of this path so as to organize an increasing braking of the mobile part during its path via the reaction effect of the mass of material surrounding the longitudinal housing.

Thus, the volume and distribution of the elastically ductile material combined with the modulus of elasticity of the latter make it possible to embody a predetermined and improved progressiveness of the braking effect according to a calculated function in keeping with the desired path of the mobile part inside the receiving element. In fact, the thickness of the elastic material surrounding the longitudinal housing at the location where the mobile part is situated at a given moment of its passage inside this longitudinal housing determines a level of reaction to the radial force and thus a level of deceleration. By determining an increasing profile of the thickness of the element around the longitudinal housing in the direction of movement of the mobile part under the effect of the load, a progressive deceleration is obtained according to a calculable function refined by successive adjustments during tests according to the behavior of all the equipment.

So as to provide the device with more safety, the receiving element advantageously comprises a shoulder in its longitudinal bore providing a crash stop for movement of the mobile part when the latter is stressed by the fall of the load.

According to a preferred embodiment of the invention, the element for receiving the mobile part is incorporated so as to be a single piece inside the anchorage part retaining the extremity of the link to which the load is secured or connected. Thus, all this anchorage part forms the body of the receiving element and, via its elasticity, helps in damping the fall of the load. This embodiment also has the advantage of reducing costs on account of the simplicity for producing the single piece element.

The embodiment study of the invention has shown that the polyurethane is a material particularly adapted to the function of the receiving element via its modulus of elasticity and its resistance in relation to the energy to be absorbed in the applications provided. However, another suitable material could be selected for other applications.

### BRIEF DESCRIPTION OF THE DRAWINGS

So as to clearly understand the invention, there now follows a non-restrictive example of a preferred embodiment with reference to the accompanying diagrammatic drawing on which:

FIG. 1 is a partial perspective view of a life line according to the invention and showing in particular one extremity anchorage and one intermediate anchorage of the latter;

FIG. 2 is a perspective view of an extremity anchorage of the life line of FIG. 1;

FIG. 3 is a side view, partially shown as a vertical section, of the extremity anchorage of FIG. 2, the mobile part equipping it being shown in the idle position; and

FIG. 4 is a view similar to FIG. 3, the mobile part being engaged in the housing of the receiving element of the extremity anchorage during its load braking function.

### DETAILED DESCRIPTION OF THE PREFERRED EMBODIMENTS

With reference to the drawing, shown at 1 is an extremity anchorage of a life line including two approximately horizontal parallel cables 2 connected at one extremity to the anchorage 1 and, at their opposing extremity, to an identical extremity anchorage (not shown on the drawing). Intermediate anchorages 12 are regularly spaced along the cables 2. Moving on the cables 2 is a known type of slide 3 forming a mobile anchorage to which a user can be linked by a head rope (not shown).

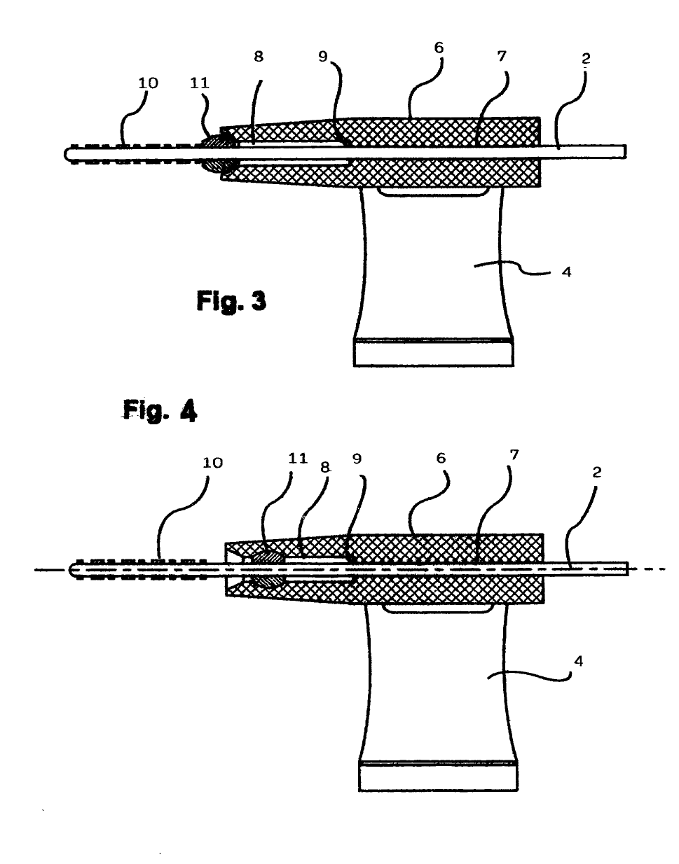

Shown on FIGS. 2 to 4 and made up of a single piece of a molded polyurethane elastic material, the extremity anchorage 1 includes a base 4 to be fixed (for example by bolting) to a receiving structure such as a floor, ceiling or wall (not shown) and a receiving element 5 which extends the base 4 at its upper extremity. The orientation of the receiving element 5 is approximately horizontal and the latter has two parallel bulging portions which are symmetrical with respect to a vertical median longitudinal plane.

Each bulging portion 6 comprises an axial longitudinal bore 7 for the passage of a cable 2 and is continued towards the rear by a longitudinal housing 8 having a larger diameter. A shoulder 9 connects the bore 7 and the housing 8.

Each cable 2 axially traverses the corresponding bulging portion 6 and, clamped onto its extremity projecting towards the rear outside the bulging portion 6, is a sleeve 10.

As shown on the drawing, the rear portion of each swelling 6 surrounding the longitudinal housing 8 has an active conical shape gradually narrowing from the front to the rear so that the thickness of the elastic material surrounding the longitudinal housing 8 increases from the rear towards the front of the latter.

Situated at the rear extremity of the extremity anchorage 1, that is at the extremity opposite the one situated on the side of the life line, is a mobile part 11 for example having the shape of an olive traversed by a cable 2 and which has an outer diameter larger than the internal diameter of the corresponding longitudinal housing 8. The mobile part 11 is blocked by the sleeve 10 clamped onto the cable 2 against the open extremity of the housing 8.

Should the user connected by means of the mobile anchorage 3 to the life line accidentally fall, a traction towards the front is automatically applied to the portion of the cables 2 connected to the anchorage 1 under the effect of acceleration of the load, thus provoking the penetration and sliding of each mobile part 11 inside the corresponding longitudinal housing 8. This movement of the mobile parts 11 inside the housings 8 results in warping of the elastic material of the conical portion of the bulging portions 6 under the effect of the radial force of the mobile parts 11 and ensures the braking and immobilization of the mobile parts and thus that of the load connected to the cables 2, thus absorbing the energy produced by the fall of the load.

The distribution of the elastic material constituting surrounding of the longitudinal housings 8 and in particular the conical shape of this surrounding makes it possible to obtain a predetermined and improved progressiveness of the braking effect.

The presence of the shoulder 9 at the bottom of each longitudinal housing 8 increases safety by providing a crash stop for movement of the corresponding mobile part 11 when the latter is stressed by the fall of the load.

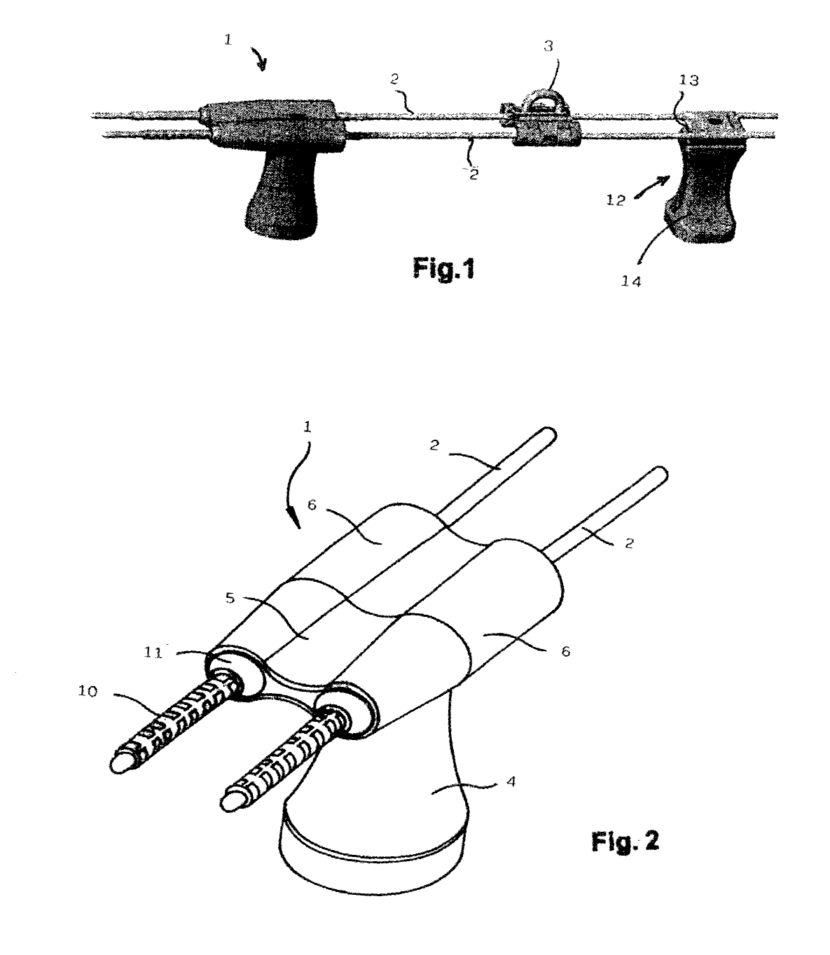

The intermediate anchorages 12 intended for avoiding any excessive bending of the cables 2 during a fall are each made up of two parts (see FIG. 1), that is an upper part 13 in metal or composite material (for example extruded aluminum or glass fiber composite) which allows easy passage of the slide 3 on the anchorage, and a polyurethane shaft 14 molded around the part 13. Should a fall occur, as for the extremity anchorage 1, a fraction of the energy is dissipated by virtue of the material and the geometry of the anchorage, the shaft 14 bending via elastic deformation and resuming its initial shape after stoppage of the fall.

The preceding description has been given solely by way of non-restrictive example and constructive additions of modifications could be made without departing from the context of the invention.

It shall be observed that the receiving element of the extremity anchorage has been described as being made of polyurethane, a material which is particularly adapted to the function of this element owing to is modulus of elasticity and resistance in relation to the energy to be absorbed in the applications provided, but another appropriate material could be selected for another application.

It shall also be noted that the receiving element may comprise several parallel longitudinal housings each co-operating with a mobile part, the various mobile parts being connected to separate loads or to a common load.

1. Device for braking a fall of a load and more particularly of a person, which comprises:
a fixed receiving element having a longitudinal housing,
a mobile part to which the load is connected, said mobile part penetrating and sliding along a path, under the effect of an acceleration of the load, in said longitudinal housing while exerting a radial force,
said longitudinal housing having an initial internal diameter which is less than the width of said mobile part so that said receiving element, via its deformation under the radial force of said mobile part, absorbs energy produced by the fall of the load,
said receiving element forming a body of a single piece to be fixed on a receiving structure and being made up of an elastic material able to elastically deform under the radial force exerted by said mobile part, so that a progressive braking of said mobile part is predetermined by shape and dimensions of the receiving element, and all the elastic material of said receiving element participating via its elasticity in braking and damping the fall of the load.

2. Device according to claim 1, wherein a section of the elastic body of the receiving element, transversal to the path of the mobile part, has an increasing thickness in the direction of this path, thus organizing an increasing braking of said mobile part during its path under a reaction effect of the elastic material surrounding the longitudinal housing.

3. Device according to claim 1, wherein the longitudinal housing of the receiving element comprises a shoulder limiting movement of the mobile part.

4. Device according to claim 1, wherein the receiving element is constituted, at least partially, of polyurethane.

5. Life line to protect persons against falls, which comprises:
at least one approximately horizontal cable,
two extremity anchorages to which said at least one horizontal cable is fixed, each of said extremity anchorages including a braking device,
a mobile anchorage circulating on said at least one horizontal cable, said mobile anchorage being adapted to be connected, via a rope, to a user exposed to a risk of falling,
intermediate anchorings placed at regular intervals along said at least one horizontal cable,
wherein said braking device comprises:
a fixed receiving element having a longitudinal housing,
a mobile part to which the load is connected, said mobile part penetrating and sliding along a path, under the effect of an acceleration of the load, in said longitudinal housing while exerting a radial force,
said longitudinal housing having an initial internal diameter which is less than the width of said mobile part so that said receiving element, via its deformation under the radial force of said mobile part, absorbs energy produced by the fall of the load,
said receiving element forming a body of a single piece to be fixed on a receiving structure and being made up of an elastic material able to elastically deform under the radial force exerted by said mobile part, so that a progressive braking of said mobile part is predetermined by shape and dimensions of the receiving element, and all the elastic material of said receiving element participating via its elasticity in braking and damping the fall of the load,
the mobile part of the braking device being placed on the at least one horizontal cable at an extremity of the receiving element opposite the one situated on the side of a section of the life line on which a stressing of the load is exerted so as to constitute a retention point for the extremity of the life line and co-operate with the receiving element for braking the fall.

6. Life line according to claim 5, wherein each intermediate anchorage includes an upper metal part used to guide said cable and a single piece shaft made of an elastic material able to bend via elastic deformation should a fall occur and resuming its initial shape after stoppage of the fall.

7. Life line according to claim 5, wherein each intermediate anchorage includes an upper part of composite material used to guide said cable and a single piece shaft made of an elastic material able to bend via elastic deformation should a fall occur and resuming its initial shape after stoppage of the fall.

8. Life line according to claim 5 including several parallel cables, wherein the receiving element of each extremity anchorage comprises a corresponding number of parallel longitudinal housings each co-operating with a mobile part, said mobile parts being connected to separate loads or to a common load.
